(19) United States
(12) Patent Application Publication
(10) Pub. No.: US 2007/0235494 A1
(43) Pub. Date: Oct. 11, 2007

(54) TAPE DISPENSER

(75) Inventors: Kenneth C. Foran, Wooster, OH (US); Stephen P. Casteel, Canal Fulton, OH (US); James K. Hawley, Avon, OH (US); Brian A. Vulpitta, Avon Lake, OH (US); Kristen Chupa, Avon, OH (US); Vanessa Ortiz, Avon, OH (US); Suzanne P. VanDenbossche, Westlake, OH (US)

Correspondence Address: Fay Sharpe / Henkel, 1100 Superior Avenue, Seventh Floor, Cleveland, OH, 44114, US

(73) Assignee: Henkel Consumer Adhesives, Inc., Avon, OH (US)

(21) Appl. No.: 11/278,194

(22) Filed: Mar. 31, 2006

(51) Int. Cl. B26F 3/02

(52) U.S. Cl. 225/39; 225/47; 225/56

(57) ABSTRACT

A tape dispenser has a tubular hub for receiving a roll of tape, and the hub has an axis and axially spaced first and second ends. A first wall extends radially outwardly of the hub at the first end, and a second wall is radially spaced from the hub and extends axially from the first wall the direction toward the second end of said hub. The hub includes a portion extending axially outwardly of the outer end of the second wall, and the first end and the latter portion of the hub are contoured for the first end of one tape dispenser to axially receive the portion of the hub of a second tape dispenser to interengage the two dispensers.

### BACKGROUND OF THE INVENTION

This invention relates to the art of dispensers for rolls of tape and, more particularly, to improvements in connection with the packaging and/or use of such dispensers.

Dispensers for rolls of tape such as cellophane tape, for example, are of course well known. Basically, such a dispenser includes a hub for rotatably supporting a roll of tape to be dispensed and, generally, a wall which circumferentially encompasses a roll of tape on the hub. Such a dispenser includes a tape guide radially spaced from the axis of the hub and which includes a serrated cutting edge for severing a portion of tape from the roll. Most often, the dispenser is made of a plastic material, and the cutting edge is either integral therewith or in the form of a metal blade attached to the tape guide. Often, the tape guide provides a radially narrow surface whereby, following severance of a length of tape from the roll, the trailing edge releases from the tape guide and adheres to the remainder of tape on the roll, requiring a user of the dispenser to separate the end of the tape from the roll and move the end back onto the tape guide in connection with dispensing another piece of tape from the roll. Moreover, it is not uncommon for a user of such tape dispensers to have a plurality of dispensers in a use location such as a desk and, heretofore, such a plurality of dispensers are disassociated with one another in the area of use which can be inconvenient if not annoying to the user. Further, such dispensers heretofore available are generally individually packaged which adds to the expense of purchasing a plurality of the dispensers at a given time. Even if a plurality of such dispensers should be offered in a single package, the orientation of the dispensers relative to one another in the package is not conducive to optimizing the size of the package and, therefore, the cost of such packaging. Still further, regardless of whether one or a plurality of such dispensers are available in a single package, heretofore the dispensers are necessarily structurally separate units which, as mentioned above, are not integrated in an area of use.

### SUMMARY OF THE INVENTION

In accordance with the present invention, a tape dispenser is provided which minimizes or overcomes the foregoing and other problems and disadvantages associated with tape dispensers heretofore available. In this respect, for example, tape dispensers in accordance with the present invention are structured for an interengaging relationship which promotes compactness and efficiency with respect to the packaging thereof and for a tandem interrelationship therebetween, if desired, in connection with their use in a given work area. More particularly in this respect, the hub of a tape dispenser in accordance with the invention includes a portion extending beyond the confines of a dispenser with respect to a roll of tape thereon for mating interengagement with a hub portion of a second dispenser of like construction, whereby a nested relationship is provided which promotes compactness in connection with packaging of a plurality of dispensers such as by shrink wrapping. Moreover, the interengaging relationship provides for the selective use of two or more dispensers in the interengaged relationship which advantageously maintains the dispensers in a common area of use in a work area such as a desk or the like. Preferably, the structures of the dispensers promotes the joining of two or more dispensers with a desired alignment therebetween, thus promoting efficiency with respect to the combining of two or more dispensers either for packaging and/or use thereof in a tandem relationship.

In accordance with another aspect of the invention, a radially elongated tape guide surface is provided to promote adherence of the distal end of a tape being dispensed to the guide so as to minimize the undesired displacement of the distal end back onto the tape roll following a dispensing operation. In accordance with yet another aspect of the invention, the tape guide is provided with inwardly extending recesses along the opposite sides thereof which facilitate engagement of the fingers of a user with the tape to initiate a dispensing operation.

It is accordingly an outstanding object of the present invention to provide improvements in the structure of dispensers for rolls of tape which promote compactness and efficiency in connection with the packaging and use of the tape dispensers.

Another object of the invention is the provision of a tape dispenser of the foregoing character which is structured for a plurality of the dispensers to be releasably interengaged in a manner which promotes compactness of a plurality of the dispensers in connection with the packaging thereof and which, optionally, provides for a plurality of the dispensers to be maintained in a tandem relationship during use.

Still another object is the provision of a tape dispenser of the foregoing character wherein alignment of adjacent dispensers during interengagement therebetween promotes the efficiency of an assembly of a plurality of the dispensers and maintaining such alignment for packaging and/or use purposes.

Yet another object is to provide a dispenser of the foregoing character with an improved tape guide structure which optimizes surface contact with respect to the distal end of tape to be dispensed and which promotes ease of access to the distal end for dispensing the tape from the roll.

### BRIEF DESCRIPTION OF THE DRAWINGS

The foregoing objects, and others, will in part be obvious and in part pointed out more fully hereinafter in conjunction with the written description of a preferred embodiment of the invention illustrated in the accompanying drawings in which:

FIG. 1 is a perspective view of the open side of a tape dispenser in accordance with the present invention;

FIG. 2 is a perspective view of the closed side of the dispenser shown in FIG. 1;

FIG. 3 is a side elevation view of the closed side of the dispenser shown in FIG. 1;

FIG. 4 is a side elevation view of the open side of the dispenser in FIG. 1; and,

FIG. 5 is a cross-sectional elevation view showing two of the tape dispensers in interconnected relationship.

### DETAILED DESCRIPTION

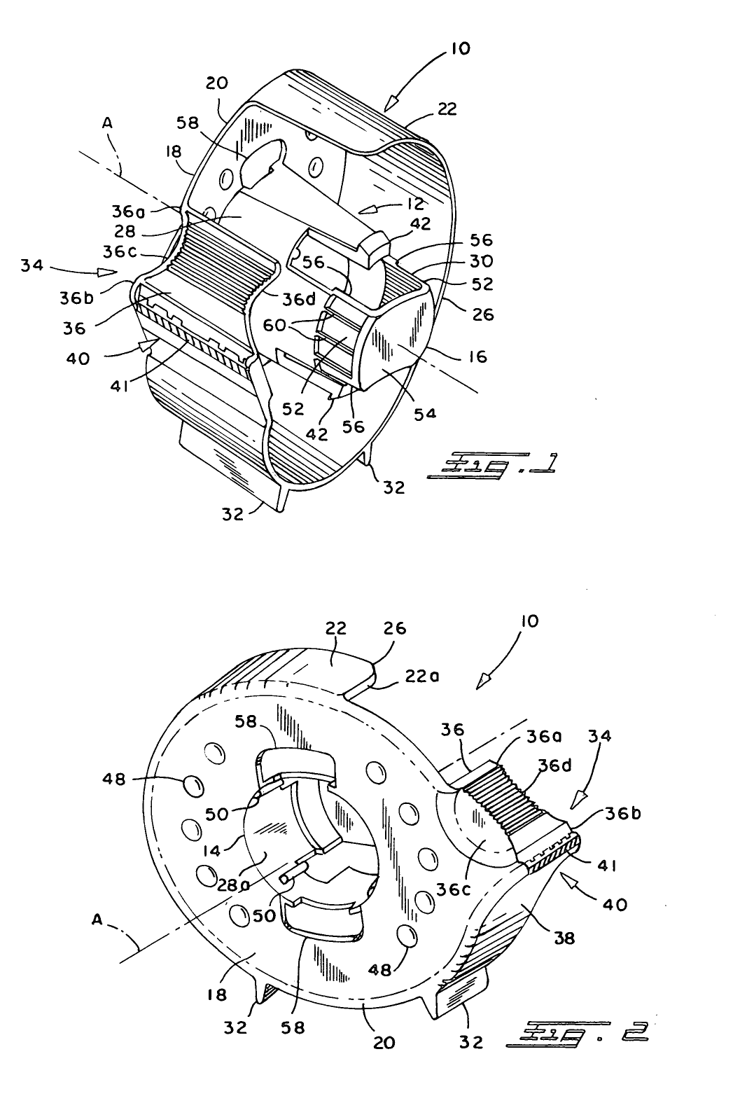

Referring now in greater detail to the drawings, wherein the showings are for the purpose of illustrating a preferred embodiment of the invention only and not for the purpose of limiting the invention, a tape dispenser 10 in accordance with the invention, as shown in FIGS. 1-4 of the drawing, is a one-piece construction, preferably of a plastic material, and comprises a tubular hub 12 having an axis A and axially opposite first and second ends 14 and 16, respectively. Dispenser 10 further includes a first wall 18 at end 14 of hub 12 and which extends radially outwardly from the periphery of the hub and has a peripheral outer edge 20, and a second wall 22 radially spaced from hub 12 and extending axially from wall 18 and, preferably, from peripheral edge 20, in the direction toward second end 16 of the hub. Wall 22 is parallel to axis A and has a circumferentially extending axially outer end or edge 26 between ends 14 and 16 of the hub. The latter relationship provides for hub 12 to have a first portion 28 between end 14 and outer edge 26 of wall 22 and a second portion 30 extending from the first portion to end 16 of the hub.

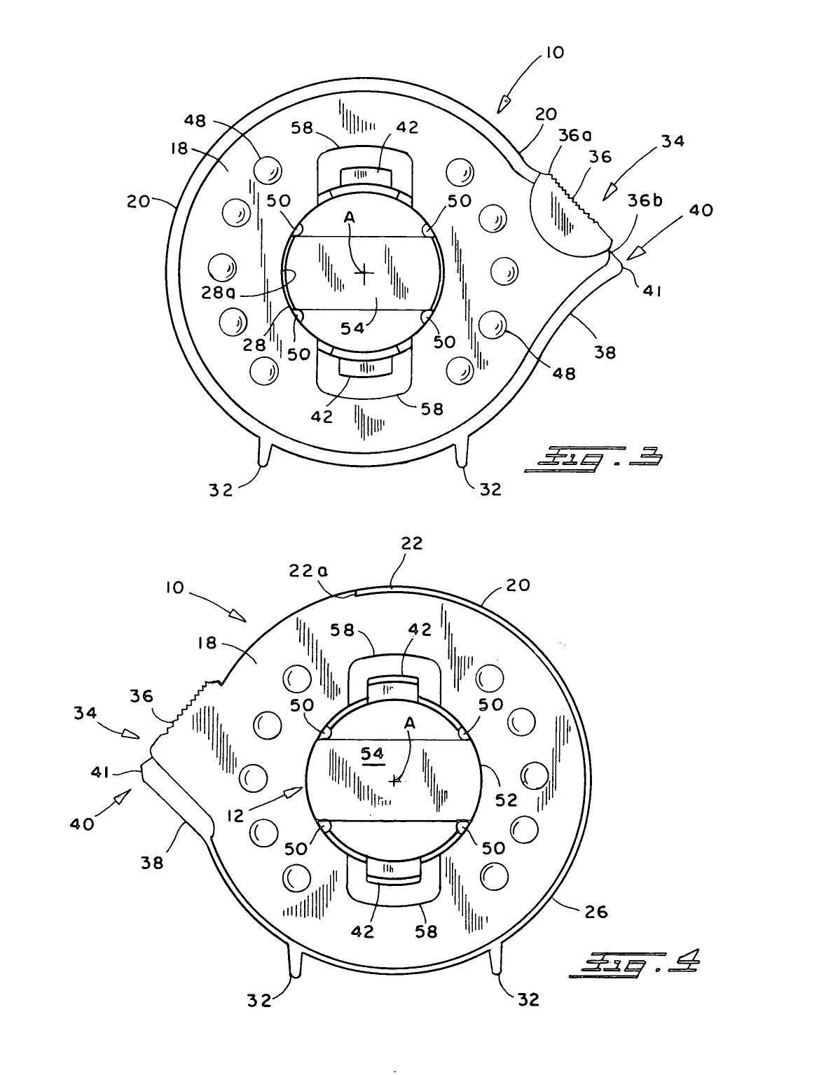

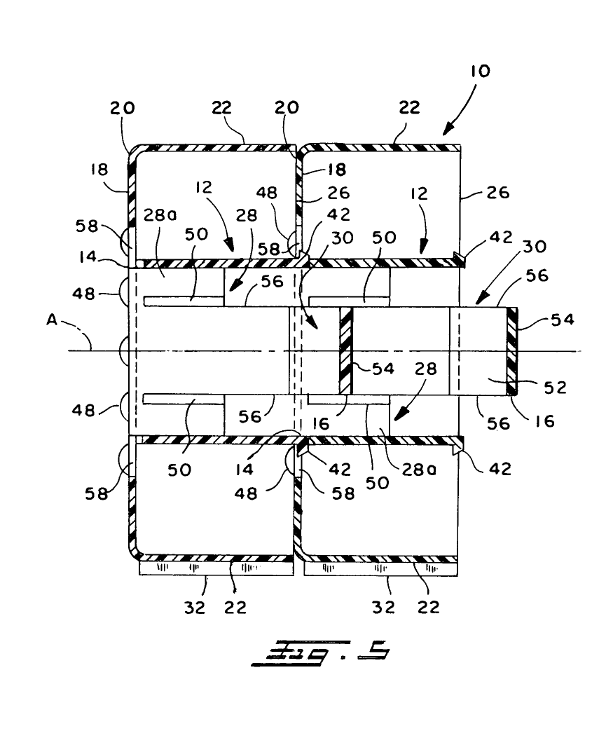

Tape dispenser 10 has a bottom portion defined by a pair of ribs or feet 32 extending axially of second wall 22 and projecting outwardly therefrom for supporting the dispenser on an underlying surface with axis A parallel to the surface. The second wall of the dispenser provides the dispenser with a front end in the form of a tape guide 34 which is defined in part by a plate portion 36 integral with first wall 18 and extending tangentially of outer edge 20 thereof and a lower plate portion 38 integral with the lower portion of second wall 22 and intersecting plate portion 36 to provide a nose 40 therebetween which provides a serrated cutting edge 41 for tape to be dispensed. Plate portion 36 has radially inner and outer ends 36a and 36b, respectively, and is planar and elongate in the direction between the inner and outer ends to optimize the area thereof for surface contact with tape on the dispenser so as to promote maintaining the end of the tape on the tape guide after a cutting operation. As best seen in FIG. 2, the upper portion of second wall 22 has a forward end 22a spaced from inner end 36a of tape guide plate 36 to provide an opening or window through which the end of the tape on a roll on the dispenser hub 12 is directed to the tape guide. As further seen in FIGS. 1 and 4, and described in greater detail hereinafter, hub 12 includes a pair of radially outwardly extending tape roll retaining tabs 42 at the outer end of first portion 28 of the hub and which, in a well-known manner, releasably hold a roll of tape on the hub while permitting rotation of the roll relative to the hub.

As best seen in FIG. 1, plate portion 36 of the tape guide has axially opposite sides 36c and 36d, each of which is arcuate and concave in the direction toward one another to optimize access to pick-up the end of tape adhered to the tape guide to initiate a tape dispensing operation. Preferably, the plastic material from which the dispenser is molded is provided with a frosted surface finish, whereby the material is translucent, and first wall 18 of the dispenser is provided with a plurality of domed windows 48 circumferentially spaced apart thereabout and highly polished so as to be transparent for viewing the amount of tape left on a roll in the dispenser.

In accordance with one aspect of the present invention, and as will be best appreciated from FIG. 5 of the drawing, the first and second portions of the hub of tape dispenser 10 are contoured for the first end of one tape dispenser to axially receive the second end of a second tape dispenser. In the embodiment illustrated, first portion 28 of hub 12 has a circular inner surface, 28a which is provided with four axially extending and circumferentially spaced apart ribs 50 which project radially inwardly and, as will become apparent hereinafter, provide guide members to promote a desired orientation between two tape dispensers during and following interengagement of the latter. Further in connection with the disclosed embodiment, second portion 30 of the hub is defined by circumferentially opposed arcuate walls 52 interconnected at the outer end of the hub by an end wall 54 and each of which arcuate walls provides a pair of circumferentially spaced apart axially extending guide surfaces 56. Each pair of guide surfaces 56 is circumferentially spaced apart to be axially slidably received between a corresponding pair of the ribs 50 when the two tape dispensers 10 are aligned for mating interengagement. The axially outer side of first wall 18 is provided with diametrically opposed openings 58 which are positioned to receive tape roll retaining tabs 42 to promote a full nesting of the assembled tape dispensers so as to minimize the axial length of the assembled dispensers. It will be appreciated that while openings 58 accommodate tabs 42, each of which in the illustrated embodiment is axially outwardly adjacent outer edge 26 of second wall 22, the tape roll retaining projections could be axially inwardly of the plane of edge 26 of wall 22, whereby openings 58 in wall 18 would not be necessary. Such positioning of the tape roll retaining tabs would reduce the width of a tape roll which could be accommodated by the dispenser, and the positioning of the tabs as shown and described herein is preferred in that the interengagement between the tabs and openings 58 further stabilizes the interengaged relationship between adjacent dispensers in addition to accommodating a wider tape roll. Preferably, the outer surface of each of the walls 52 of second portion 30 of the hub are provided with a plurality of circumferentially spaced apart axially extending projections 60 which frictionally interengage with the inner surface 28a of first portion 28 of the hub when the two tape dispensers are axially interengaged, thus to restrain unintended separation thereof.

The ability to align and axially interengage a plurality of tape dispensers in the foregoing manner promotes efficiency with respect to assembling a plurality of dispensers as well as the compactness of the assembly in connection with the packaging thereof. Furthermore, such packaging could be of a plurality of dispensers providing a variety of tapes available to a consumer. Furthermore, a plurality of the dispensers having the same or a variety of tapes can be maintained in assembled relationship and supported on an underlying surface such as a desk for use by the consumer.

While considerable emphasis has been placed herein on the structures and structural interrelationships between component parts of a preferred dispenser, it will be appreciated that other embodiments can be devised and that many changes can be made in the preferred embodiment without departing from the principles of the invention. Accordingly, it is to be distinctly understood that the foregoing descriptive matter is to be interpreted merely as illustrative of the invention and not as a limitation and that it is intended to include other embodiments and all modifications of the preferred embodiment insofar as they come within the scope of the appended claims or the equivalents thereof.

1. A tape dispenser comprising a tubular hub for receiving a roll of tape and having an axis and axially spaced first and second ends, a first wall extending radially outwardly of said hub at said first end, a second wall radially spaced from said hub and extending axially from said first wall in the direction toward said second end of said hub and having an outer end, said hub including a portion extending axially outwardly of said outer end of said second wall to said second end, and said first end and said portion of said hub being contoured for the first end of one tape dispenser to axially receive said portion of the hub of a second tape dispenser.

2. A tape dispenser according to claim 1, wherein said hub includes tape roll retaining tabs axially between said first and second ends thereof.

3. A tape dispenser according to claim 1, wherein said second wall includes a tape guide and an opening for directing tape on a roll of tape on said hub toward said tape guide, said tape guide having inner and outer ends with respect to the direction of tape dispensing relative thereto, and at least a portion of said tape guide being narrower than the tape on a roll of tape on said hub.

4. A tape dispenser according to claim 1, wherein said second wall includes a pair of ribs for supporting the dispenser on an underlying surface with said axis parallel to the surface.

5. A tape dispenser according to claim 1, wherein said hub includes tape roll retaining tabs axially between said first and second ends thereof and said first wall includes openings for receiving the tabs of a first dispenser when said portion of the hub of the first tape dispenser is received in the first end of a second tape dispenser.

6. A tape dispenser according to claim 1, wherein said first end of said hub includes an inner surface including axially extending guide members and said portion of said hub includes guide surfaces for interengaging with said guide members when the first end of the one tape dispenser receives said portion of the hub of a second tape dispenser.

7. A tape dispenser according to claim 6, wherein said hub includes tape roll retaining tabs axially between said first and second ends thereof and said first wall includes openings for receiving the tabs of a first dispenser when said portion of the hub of the first tape dispenser is received in the first end of a second tape dispenser.

8. A tape dispenser according to claim 7, wherein said second wall includes a tape guide and an opening for directing tape on a roll of tape on said hub toward said tape guide, said tape guide having inner and outer ends with respect to the direction of tape dispensing relative thereto, and at least a portion of said tape guide being narrower than the tape on a roll of tape on said hub.

9. A tape dispenser according to claim 8, wherein said second wall includes a pair of ribs for supporting the dispenser on an underlying surface with said axis parallel to the surface.

10. A tape dispenser comprising a tubular hub for receiving a roll of tape, said hub having an axis and axially opposite ends, a first wall extending radially outwardly of one of said ends of said hub and having a peripheral edge spaced radially outwardly of said one end, a second wall extending axially from the peripheral edge of said first wall and having an axially outer edge between the opposite ends of said hub, whereby a portion of said hub axially inwardly of the other of said opposite ends thereof extends axially outwardly of the outer edge of said second wall, a tape guide extending axially from said peripheral edge of said first wall and spaced along said peripheral edge to provide an opening for tape on a roll of tape on said hub to be directed toward said tape guide, said hub including tape roll retaining tabs axially between said opposite ends thereof, said hub at said one end thereof having an inner surface extending toward the other end of the hub, and said portion of said hub having an outer surface, and said inner and outer surfaces being contoured for mating interengagement.

11. A tape dispenser according to claim 10, wherein said first wall includes tape roll retaining tab openings.

12. A tape dispenser according to claim 10, wherein said tape guide includes inner and outer ends with respect to the direction of tape dispensing and has a given width at said inner end and a width between said inner and outer ends less than the given width.

13. A tape dispenser according to claim 10, wherein said tape guide has inner and outer ends with respect to the direction of tape dispensing and inwardly arcuate side edges between said inner and outer ends.

14. A tape dispenser according to claim 10, wherein said outer surface of said portion of said hub includes axially extending radial projections.

15. A tape dispenser according to claim 10, wherein said second wall includes a pair of ribs for supporting the dispenser on an underlying surface with said axis parallel to the surface.

16. A tape dispenser according to claim 10, wherein said inner surface at said one end of the hub includes axially extending guide members projecting radially inwardly therefrom, and said portion of said hub includes axially extending guide surfaces.

17. A tape dispenser according to claim 16, wherein said first wall includes tape roll retaining tab openings.

18. A tape dispenser according to claim 17, wherein said tape guide includes inner and outer ends with respect to the direction of tape dispensing and has a given width at said inner end and a width between said inner and outer ends less than the given width.

19. A tape dispenser according to claim 18, wherein said tape guide includes inwardly arcuate side edges between said inner and outer ends.

20. A tape dispenser according to claim 19, wherein said outer surface of said portion of said hub includes axially extending radially outwardly projecting ribs between said axially extending guide surfaces.

21. A tape dispenser according to claim 20, wherein said second wall includes a pair of ribs for supporting the dispenser on an underlying surface with said axis parallel to the surface.

22. A tape dispenser according to claim 20, wherein said portion of said hub includes diametrically opposed arcuate walls each having circumferentially spaced axially extending edges, said edges providing said guide surfaces, and said ribs being on said arcuate side walls between said edges.
